(19) United States
(12) Patent Application Publication
(10) Pub. No.: US 2003/0126015 A1
(43) Pub. Date: Jul. 3, 2003

(54) System and Method for Cardmember Acquisition

(76) Inventors: Jenny Chan, New York, NY (US); Robert P. Cichon, Peoria, AZ (US); David S. Connelly, Gilbert, AZ (US); Rhene Meyer, Phoenix, AZ (US)

Correspondence Address: Michelle, Whittington, SNELL & WILMER, LLP, One Arizona Center, Phoenix, AZ, 85004-2202, US, mwhittington@swlaw.com, 602-382-6275, 602-382-6070

(21) Appl. No.: 10/300,474

(22) Filed: Nov. 19, 2002

Related U.S. Application Data
(60) Provisional application No. 60/337,210, filed on Nov. 19, 2001.

(51) Int. Cl. G06F 17/60

(52) U.S. Cl. 705/14

(57) ABSTRACT

### Abstract of Disclosure

A cardmember acquisition system and method according to various principles of the invention generally includes an advisement to an existing cardmember to refer-a-friend to apply for a card. The advisement from the host includes an embedded customized URL having a unique ID identifying the cardmember. The host can track and monitor the unique ID back to the cardmember throughout the referral process. In one particular embodiment, a cardmember receives an electronic advisement from the host including the specialized URL. The cardmember forwards the specialized URL to a friend and invites the friend to apply for card membership. The friend completes and submits an application to the host, which includes the unique ID. Upon approval of the application, the cardmember receives notification and an incentive.

Field of Invention
 The present invention relates generally to a system and method for customer acquisition and, in particular, to a member referral and incentive system for customer acquisition.

### Cross Reference to Related Applications

The present application claims priority to U.S. Provisional Patent Application No. 60/337,210 filed November 19, 2001, the entire contents of which are incorporated herein by reference.

### Background of Invention

Financial card companies frequently solicit credit applications using the internet via email invitations, web page banners, and pop-up ads. As these companies have recognized, advertising on the internet has several advantages, such as minimal advertising costs, immediate responses, and a wide range of consumers. There are, however, disadvantages to online advertising including, for example, a decreased ability to advertise and solicit to a targeted group of consumers. Email addresses are unlike postal addresses that provide a geographical location for the companies to use in marketing campaigns. Simply put, when charge card companies engage in mass solicitation for card applications via the internet, consumers from all over the world are often being invited to apply. While many of these applicants will not meet the set criteria established by the card companies for card membership, the company usually spend valuable time and resources reviewing all the submitted applications.

Referral and incentive programs are well known. Often times, companies target a specific group of consumers as type-A customers or customers who exhibit a preferred profile. The company may then ask the type-A customer to refer a friend to join, for example, a health club membership, a country club membership, and on-line services, such as coupon, book and music clubs. In this manner, it is the hope of the company that the type-A type customers, who already fit the company's desired profile, will promote membership to their peers who are presumably of similar type-A. To entice the customer to solicit or market on behalf of the company, the company may offer the customer an incentive. For example, a health club may provide current customers one free month of membership for every friend referred.

Referral and incentive programs on the internet have many advantages. Similar to the advantages associated with the company's email solicitations, customers can refer friends to various websites in a non-invasive and low cost manner. There are, however, disadvantages associated with online referral programs. For example, customers may be reluctant to participate in a referral program that requires them to reveal their friends" names and/or email addresses to a company, and some programs require the customer to spend time and effort manually inputting information into lengthy participant forms, or the like. Accordingly, an improved system and method for membership referral and incentive is needed. Particularly, a system and method for customer membership acquisition via the internet, that is non-invasive, requires little or no manual input by the customer, and provides a reliable method of receiving the incentive is desired.

### Summary of Invention

The present invention overcomes the problems outlined above and provides an improved customer acquisition system and method. In general, a method for new member acquisition in accordance with one embodiment of the invention includes, generating a specialized URL having a unique ID associated to a current member embedded therein, and sending an advisement to a current member to refer-a-friend to submit a membership application. The advisement includes the URL and the unique ID thereby facilitating tracking of the unique ID back to the current member. The host notifies the friend of the approval of the application. The approved application is associated with the current member through the unique ID. The current member is provided a bonus upon the approval of the friend's application and the friend is notified of the approval.

Another embodiment of the invention generally includes receiving an advisement from a host to refer-a-friend to apply for membership. The advisement includes a unique ID identifying a current member embedded in a specialized URL. The host is able to track the unique ID and monitor any referring activity. The specialized URL having the embedded ID is forwarded to a friend inviting the friend to apply for membership. The current member receives a bonus from the host in response to the friend's successful membership.

In yet another embodiment of the invention, a method for new member acquisition generally includes, receiving an invitation from a current member to apply for membership. The invitation includes a specialized URL generated by a host and has a unique ID embedded therein. The unique ID being associated with the current member. The recipient opens the specialized URL having the unique ID embedded therein and submits a membership application to the host. The application having the unique ID associated with it. The recipient receives notification of the status of the application, whereby if the status is approved then the current member receives a bonus from the host.

### Brief Description of Drawings

These and other features, aspects and advantages of the invention will become better understood with reference to the following description, appending claims, and accompanying drawings wherein like numerals represent like elements, and:

Figure 1 illustrates an exemplary system for customer acquisition;

Figure 2 is an exemplary flowchart describing one embodiment of customer acquisition for a host in accordance with the invention;

Figure 3 is an exemplary flowchart describing one embodiment of customer acquisition for a cardmember in accordance with the invention; and

Figure 4 is an exemplary flowchart describing one embodiment of customer acquisition for a referral in accordance with the invention.

### Detailed Description

The present invention provides an improved system and method for customer acquisition having an exemplary usefulness in the financial card industry. Although the system and methods disclosed herein may be suitable for products in a variety of applications, the present invention is conveniently described with reference to the transaction card industry, and more particularly to cardmember applications and acquisition in the charge card industry. It should be recognized that the invention has equal application to various other industries desiring an improved system and method for membership acquisition, such as banking services, long distance phone service, cellular phone service, internet service, magazine/journal subscriptions, time-share or other vacation packages, loyalty programs such as frequent flyer (Delta Sky Miles™), guest (Starwood™hotel program), and American Express®Membership Rewards™, automotive and appliance maintenance service, and internet pharmacy.

The present invention relates to a program that facilitates providing an incentive to cardmembers to refer others (e.g., friends, organizations, etc.) to apply for a charge card using a cost-effective online channel for card acquisition. Cardmembers are encouraged to communicate and promote the benefits of card membership to friends and family through, for example, personal emails, thereby providing personalized targeted solicitation. Other benefits include reduced host costs for acquiring cardmembers by, for example, a pay-for-performance system (e.g., if a referral is approved for a card, then the cardmember is rewarded), encouraging publicity from existing cardmembers, and leveraging existing URL (universal resource locator) architecture to build card membership.

As used herein, the following terms have the meaning defined below or their equivalence:

"Account number" includes any device, code, number, letter, symbol, biometric or other identifier/indicia suitably configured to allow the consumer to interact or communicate with the system, such as, for example, authorization/access code, personal identification number (PIN), Internet code, other identification code, and/or the like which is optionally located on a rewards card, charge card, credit card, debit card, prepaid card, telephone card, smart card, magnetic stripe card, bar code card, transponder, radio frequency card and/or the like. The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number 0000 0000 0000 0000. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer.

"Card" includes any suitable device having an associated account, such as, for example, a transaction card, financial card, rewards card, charge card, credit card, debit card, prepaid card, telephone card, smart card, magnetic stripe card, bar code card, radio frequency card and/or key fob. One skilled in the art will appreciate that a "card" is not limited to a physical device; rather, the card may include an account number associated with an account, wherein the account may be located on the card or remote from the card.

"Cardmember" includes any currently subscribed person or entity having a card as defined herein. As used herein, the term end user, consumer, customer, cardmember, business or merchant may be used interchangeably with each other, and each shall mean any person, entity, machine, hardware, software and/or business.

"Friend" includes any suitable person, entity, prospect, acquaintance, or the like receiving a notification from a cardmember regarding card membership.

"Host" includes any suitable financial institution issuing or overseeing card acquisition, distribution or collection. Host may also include the computing systems and such used by the institution. The host may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

In general, the various systems and methods of the invention include a customized, unique link that facilitates the identification of a customer. The link or URL is configured so that the host can track the customer's referral process and provide a bonus back to the customer. For example, when a cardmember's friend applies for a card using the principles of the invention, the host can track the specialized URL link throughout the application process and subsequently provide a bonus back to the cardmember when the friend is approved for a card.

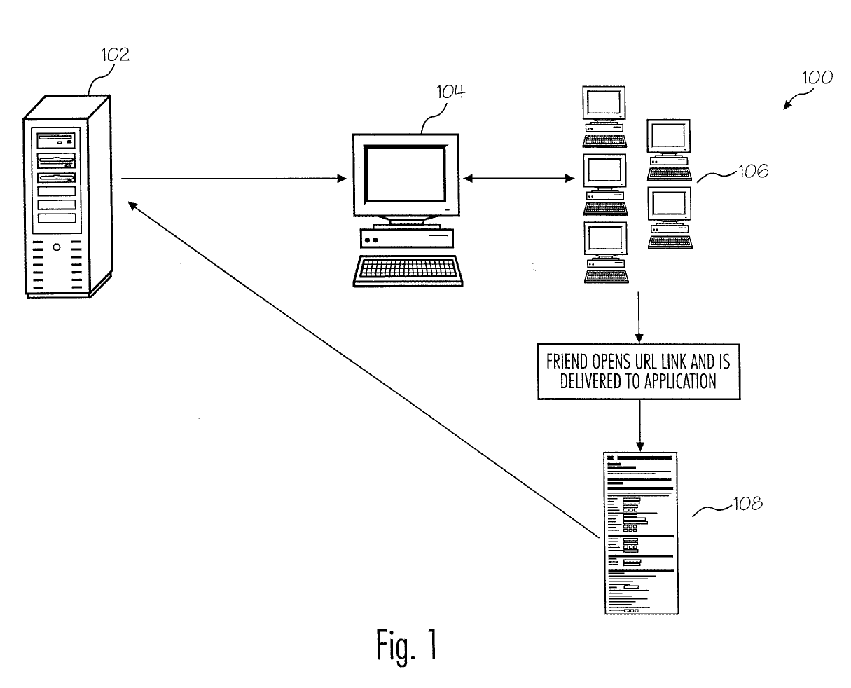

Referring to Figure 1, a system 100 for cardmember acquisition according to various principles of the invention is shown. System 100 generally includes a host server 102, a cardmember computing system 104, one or more friend computing systems 106, and a communication network therebetween (generally shown with arrows). In addition, system 100 includes a specialized URL link 108 generated by host server 102 for facilitating the tracking, identifying, and/or rewarding of a cardmember through, for example, the cardmember computing system 104. Host 102 may include, for example, a processor for processing digital data, a memory coupled to the processor for storing digital data, an input digitizer coupled to the processor for inputting digital data, and an application program stored in the memory and accessible by the processor for directing the processing of digital data by the processor.

One or more databases may be included in host 102 for storing client data, merchant data, financial institution data and/or like data that can be used in association with the invention. One skilled in the art will also appreciate that, for security reasons, any databases, systems, or components of the present invention may include any combination of databases or components at a single location or at multiple locations, wherein each database or system includes any of various suitable security features, such as firewalls, access codes, encryption, de-encryption and the like.

The database may be any type of database, such as relational, hierarchical, object-oriented, and/or the like. Common database products that may be used to implement the databases include DB2 by IBM (White Plains, NY), any of the database products available from Oracle Corporation (Redwood Shores, CA), Microsoft Access by Microsoft Corporation (Redmond, Washington), or any other database product. The database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a key field in each of the manufacturer and retailer data tables. A key field partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

Cardmember computing system 104 may include, for example, a computing unit in the form of a personal computer, although other types of computing units may be used including laptops, notebooks, hand held computers, cellular phone, personal digital assistant, set-top boxes, and the like. System 104 generally includes a display and input means, e.g., keyboard, mouse, touch screen, voice recognition software. As those skilled in the art will appreciate, cardmember computing system 104 will typically include an operating system (e.g., Windows NT, 95/98/2000, Linux, Solaris, etc.) as well as various conventional support software and drivers typically associated with computers. System 104 can be in a home or business environment with suitable access to a network. In an exemplary embodiment, access is through the internet through a commercially-available web-browser software package.

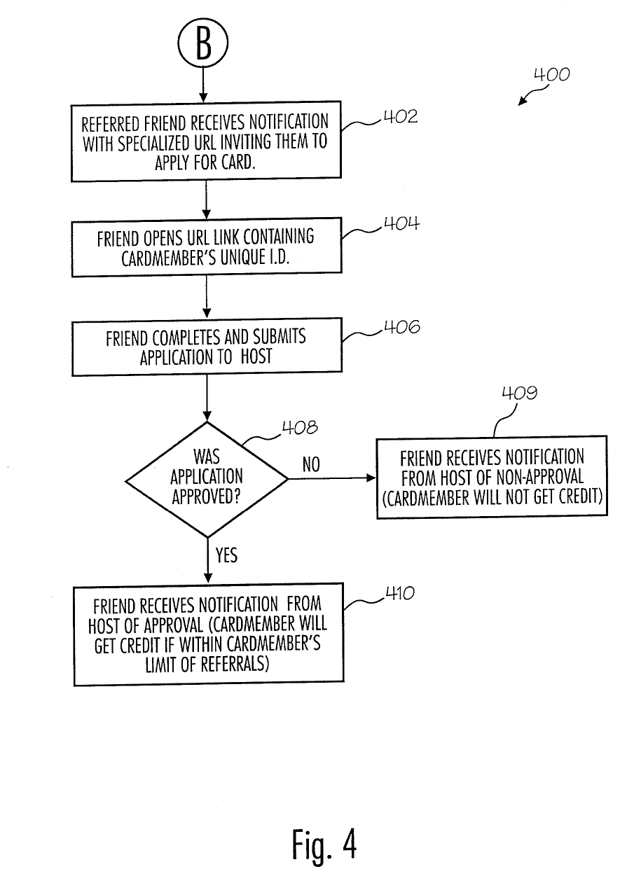

Friend computing system 106 is generally similar in structure and function to cardmember computing system 104. It should be noted that the number of friend computing systems may be more or less than the illustrative number of systems shown in Figure 4.

In general, the specialized URL link 108 facilitates identification of a cardmember (e.g., cardmember system 104), so the host can facilitate the tracking of the progress of any referrals by the cardmember. Host server 102 generates the specialized URL for the cardmember and forwards it to the cardmember, for example, in an email. The cardmember passes the URL containing the unique ID on to a friend. In one particular embodiment, the cardmember promotes card membership to the friend and asks the friend to apply for a card. If the referral (friend) is successful in joining card membership, then the host, by monitoring the specialized URL, is able to reward the cardmember. Additional details regarding specialized URL link 108 are discussed below.

Communication between the parties (i.e., host 102, cardmember system 104, and friend system 106), is accomplished through any suitable communication means for exchanging data or transacting business, such as, for example, a telephone network, intranet, internet, extranet, WAN, LAN, satellite communications, online communications, off-line communications, wireless communications, and/or the like. It is noted that the network may also be implemented as other types of networks, such as an interactive television (ITV) network.

As will be appreciated by one of ordinary skill in the art, a cardmember acquisition system in accordance with the various principles of the invention may be embodied as a method, a data processing system, a device for data processing, and/or a computer program product. Accordingly, the invention may take the form of an entirely software embodiment, an entirely hardware embodiment, or an embodiment combining aspects of both software and hardware. Furthermore, the invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

It will be understood that each functional block of the accompanying diagrams and flowchart illustrations can be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. In addition, the invention may be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Software elements may be implemented with any programming or scripting language such as C, C++, Java, COBOL, assembler, PERL, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like.

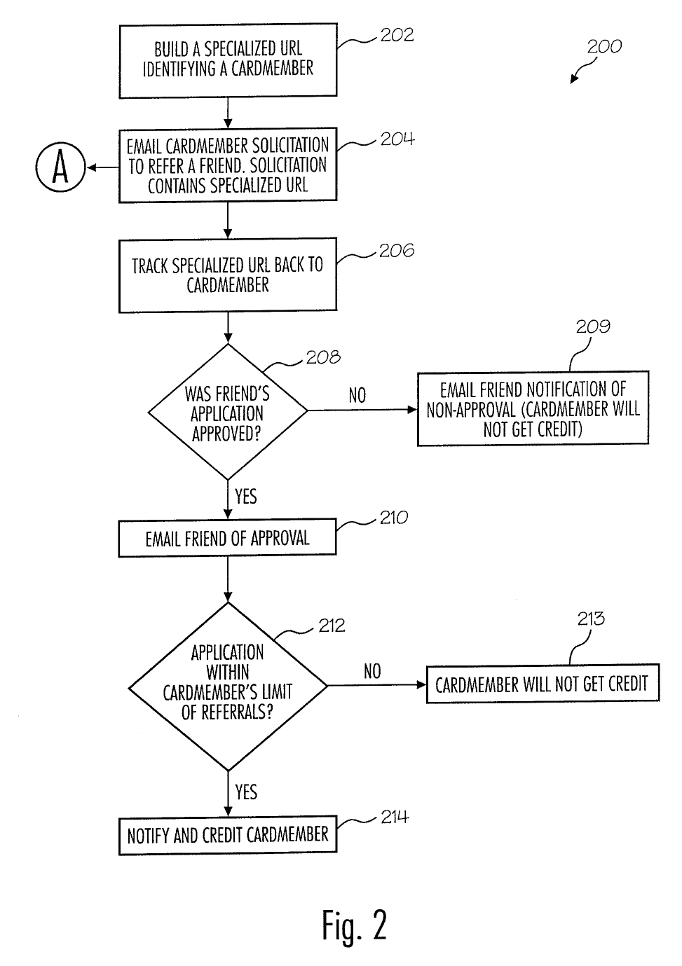

Referring to Figure 2, an exemplary flowchart 200 describing one embodiment of a cardmember acquisition system is shown. In general, the host builds a specialized or customized URL for each cardmember that identifies the cardmember (step 202). In one exemplary embodiment, this process is completed by an existing mainframe system that builds a flat file with the key information attached to the email address of the specific cardmember. This information is then sent to an email group/system and the emails are generated with the appropriate URL attached. After the build process for the email campaign is completed, the emails are then sent to the clients. A query string in the URL contains a unique ID number or key embedded in the URL that is specific to the cardmember. Embedding the key permits the host to be able to track-back to the specific card member.

In one embodiment, the host generates an advisement containing the specialized URL an emails it to cardmember (step 204). The URL includes, for example, a specific text block that can be copied from an email and sent to the friends of the cardmember. Alternatively, the entire email can be forwarded. The host can obtain the cardmember's email in a variety of ways such as, in an application or online registration. For instance, the host may offer the cardmember an incentive or bonus for referring friends to apply for card membership. In other words, the cardmember receives a request or solicitation from the host to promote card membership to friends, and upon approval of a friend's membership, the cardmember may be rewarded with a bonus.

The email from the host may suitably include the specialized URL which identifies the recipient cardmember. In one particular embodiment, the URL link may be disabled in certain situations or while at certain locations, for example, during certain time periods and/or when the host sends the link to the cardmember address. In other words, the URL link cannot be "clicked-on" or activated by the cardmember when received by the host. This may help to avoid cardmember confusion when receiving the email from the host since the cardmember could misinterpret the advisement and try to apply for another card.

The host may utilize various criteria for selecting individual cardmembers to receive the advisement. For instance, the host may consider market studies, target groups, or review current membership limits, paying and/or spending habits to select cardmembers. In an exemplary embodiment, the host generally desires to expand card membership to others having the same or similar criteria as a selected cardmember. Alternatively, the host may simply send out a blanket advisement to all cardmembers without targeting a particular class or group of members.

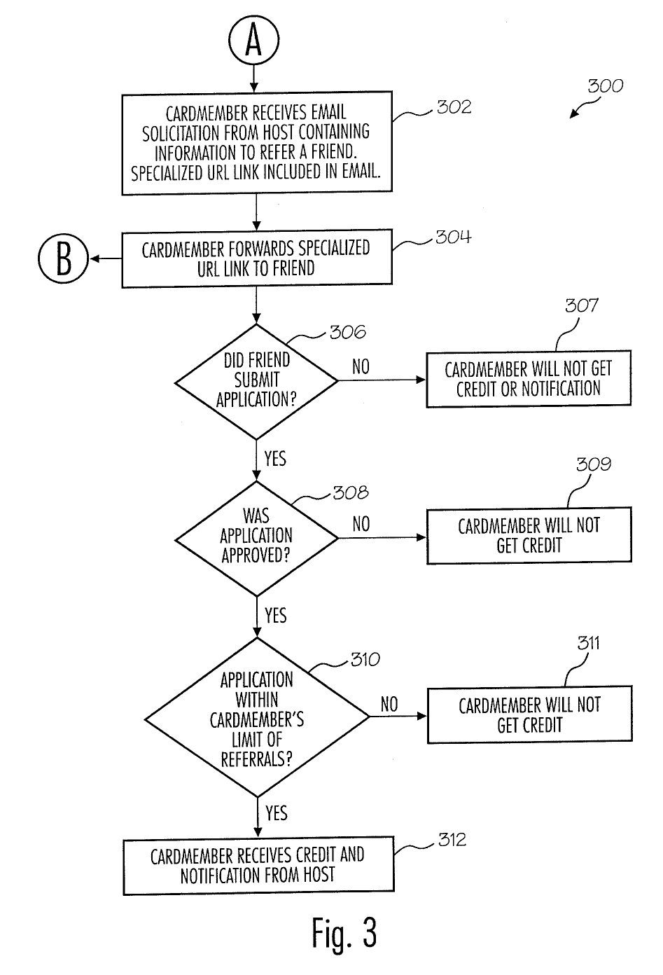

The cardmember steps upon receipt of the advisement from the host (beginning at A of step 204) will be discussed below in Figure 3. The specialized URL containing the unique ID is passed to the cardmember who in turn passes it to one or more friends. In general, the host is suitably configured to track the specialized URL back to the cardmember throughout the referral process (step 206) by, for example, extracting the key or unique ID from the URL and building an accounting for the cardmember. The accounting is stored in a database in the host.

More particularly, when a friend submits an application for a card using the principles of the invention, the host associates the friend's application to the cardmember using the unique ID embedded in the URL. The system queries whether the friend's application was approved (step 208), and if not, then the host notifies the friend that the application was declined (or pending for further information) and the cardmember will not receive a bonus credit (step 209). If the application was approved, the friend is notified (step 210). In one particular embodiment, the friend is notified via email of the outcome of the application decision process.

In one embodiment, the system may include a counter tracking the number of approved referral applications. In this embodiment, there may be a limit on the number of approved referral applications from which a cardmember may receive credit. This may be desirous to defer the cardmember from forwarding the advisement to a mass number of people who likely are not the cardmember's acquaintances. By tracking the unique ID as described above, the host is able to determine whether the approved application is within the cardmember's limit of approved referred applications (step 212). If the application exceeds the limit or the cardmember has already met the preset limit of approved applications, then the cardmember will not receive a bonus credit (step 213). If the approved application is within the cardmember's limit of approved referred applications, then the cardmember is notified and will be credited a bonus (step 214).

In one particular embodiment, the cardmember may receive a bonus or partial bonus at any point in the process, such as, for example, a 1/3 bonus for sending the email on to a friend, a 1/3 bonus for the friend submitting an application and a 1/3 bonus upon approval of the friend's application.

The cardmember may be notified of the referral approval and bonus by any suitable means such as, email, voice mail, phone, page, regular mail and/or by card statement. The system may optionally include a notification to the cardmember that a friend has submitted an application for card membership. The cardmember may also be notified of the number of friends that have applied for membership and/or the number of the friends that were approved for membership. In that regard, the system may include a reporting feature which tracks and monitors the unique ID of the cardmember and provides an internal and/or an external reporting of the number of referred applications (e.g., applied for, approved, declined).

Referring now to Figure 3, an exemplary flowchart 300 describing an embodiment of a cardmember acquisition system is shown. In general, the cardmember receives an advisement from the host containing information on a referral incentive program (step 302). The advisement includes a specialized URL link generated by the host which identifies the cardmember, as discussed above.

The cardmember forwards the specialized URL link to a friend inviting the friend to apply for a card, thereby promoting card membership (step 304). In one embodiment, the host emails the cardmember the advisement and the cardmember simply uses the "forward" option to send the entire advisement to a friend. In this particular embodiment, the URL link in the advisement may still be disabled when the friend receives it. To activate the URL, the friend can use the "cut-and-paste" functions to put the URL in the web browser line, thereby linking the friend to an application, e.g., an application web page. In another embodiment, the cardmember uses a "copy" function to place the URL in a new email to the friend. In this embodiment, the URL will activate when the friend opens the email. Thus, the cardmember is able to promote card membership to one or more friends without requiring the cardmember to enter a single keystroke. The steps taken by the referred friend upon receipt of the promotion from the cardmember (beginning at B of step 304) will be discussed below in Figure 4.

As previously mentioned, the system uses the specialized URL containing the unique ID to track and monitor the referral process of the cardmember. In this regard, the host determines whether the friend submits an application as a result of the cardmember's promotion (step 306). If not, then the cardmember will not receive notification of a friend's application or a credit from the host (step 307). If the friend submits an application for card membership, then the system queries whether the application was approved, declined or is pending (step 308). If the friend's application was not approved, then the cardmember does not receive a bonus credit from the host (step 309). If the application was approved, then the system determines whether the approved application was within the cardmember's limit of approved referral applications (step 310). As previously mentioned, the system may include an accounting or counter for the cardmember to track the number of approved referral applications associated with a particular URL. If the approved application exceeds the cardmember's limit, then the cardmember will not receive bonus credit (311). If the approved application is within the cardmember's limit of approved referred applications, then the cardmember receives notification and bonus credit from the host (step 312). The cardmember may be notified of the referral approval and bonus by any suitable means such as, pager, voice mail, email, regular mail and/or by card statement.

Referring to Figure 4, an exemplary flowchart 400 describing an embodiment of a cardmember acquisition system is shown. In general, the referred friend receives a notification from the cardmember inviting them to apply for a card (step 402). The notification includes the specialized URL link generated by the host which identifies the cardmember.

The friend opens or activates the URL link containing the cardmember's unique ID (step 404). Depending on how the cardmember sent the notification to the friend, the friend may be able to click on the URL link to open it or may cut-and-paste the link to a web browser line. In one embodiment, when the friend opens the link, the system routes the friend to an application webpage.

The host may provide a suitable website or other internet-based graphical user interface which is accessible by users. In one embodiment, Netscape web server, IBM Websphere Internet tools suite, the IBM DB2-UDB database platform and the Sysbase database platform are used in conjunction with the Sun Solaris operation system platform. Additionally, components such as JBDC drivers, IBM connection pooling and IBM MQ series connection methods may be used to provide data access to several sources. The term webpage as it is used herein is not meant to limit the type of documents and applications that might be used to interact with the user. For example, a typical website might include, in addition to standard HTML documents, various forms, Java applets, Javascript, active server pages (ASP), Java Server Pages (JSP), common gateway interface scripts (CGI), extensible markup language (XML), dynamic HTML, cascading style sheets (CSS), helper applications, plug-ins, and the like.

The friend completes and submits the card application to the host (step 406). In one embodiment, the process occurs online and the friend completes the application directly onto a webpage. Alternatively, the friend may print an application from a webpage, write-in the information, and send the application via mail or scan and submit the application to the host online. As long as the specialized URL is in tact, the host is able to track the application back to the cardmember. In one embodiment, upon printing the application, the system prints the specialized URL onto the application in the form of a number, code and/or bar code for later reading after receipt of the paper application by the host.

The submitted application is reviewed by the host or similar entity. The system queries whether the friend's application was approved (step 408) and if not, then the friend is notified of the non-approval and the cardmember does not receive a bonus credit (step 409). If the friend's application is approved, then the friend receives notification from the host of the approval and the cardmember is credited with a bonus incentive, provided the approved application is within the cardmember's limit of approved referrals (step 410).

It should be appreciated that the particular implementations shown and described herein are illustrative of the invention and its best mode and are not intended to otherwise limit the scope of the present invention in any way. Those skilled in the art having read this disclosure will recognize that changes and modifications may be made to the embodiments without departing from the scope of the present invention. For example, while conveniently described in connection with the financial card industry, and in particular the charge card industry, the present invention is not so limited. Rather, a variety of industries desiring an improved approach to membership acquisition may benefit from the system and methods of the present invention as expressed in the claims. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms comprises, comprising, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as essential or critical.

Claims

1. A method for new member acquisition comprising:
generating a specialized URL having a unique ID associated to a current member embedded therein;
sending an advertisement to said current member to refer-a-friend to submit a membership application, said advisement including said URL and said unique ID;
tracking said unique ID from said application back to said current member;
notifying said friend of an approval of said application;
associating said approved application with said current member using said unique ID; and
providing said current member a bonus.

2. The method of claim 1 further comprising:
tallying said approved application; and
providing said current member said bonus only if said tally is within a preset limit of member referrals.

3. The method of claim 1, wherein said sending comprises emailing said advisement.

4. The method of claim 1, wherein said method is for new cardmember acquisition and said member application comprises a financial card application.

5. The method of claim 1, wherein sending said advisement comprises configuring said URL having said unique ID embedded therein to be disabled upon receipt of said current member and activated when said current member forwards said URL to a friend.

6. A method of new member acquisition comprising:
receiving an advisement from a host to refer-a-friend to apply for membership, said advisement including a unique ID identifying a current member embedded in a specialized URL, said unique ID is tracked by said host and used to monitor any referring activity;
forwarding to a friend said specialized URL having said embedded ID and inviting said friend to apply for membership; and
receiving a bonus from said host in response to said friend's successful membership.

7. Th method of claim 6, wherein said forwarding requires no keystroke entry.

8. The method of claim 6, wherein said forwarding comprises emailing said friend and using "cut-and-paste" functions to forward said URL.

9. Th method of claim 6, wherein said forwarding comprises emailing said friend by using a "forward" function.

10. The method of claim 6, wherein receiving said bonus only if said friend's successful membership is within a present limit of referrals.

11. The method of claim 6, wherein said method is for new cardmember acquisition and said membership comprises a financial card application.

12. The method of claim 6, wherein receiving said bonus comprises receiving a statement from said host including said bonus.

13. A method for new member acquisition comprising:
receiving an invitation from a current member to apply for membership, said invitation including a specialized URL generated by a host and having a unique ID embedded therein, said unique ID associated with said current member;
opening said specialized URL having said unique ID embedded therein;
submitting, to said host, a membership application having said unique ID associated with said application; and
receiving notification of a status of said application, whereby if said status is approved then said current member receives a bonus from said host.

14. The method of claim 13, wherein opening comprises "clicking" on said URL.

15. The method of claim 13, wherein opening comprises "cutting-and-pasting" said URL to a web browser line.

16. The method of claim 13, wherein said method is for new cardmember acquisition and said membership application comprises a financial card application.

17. The method of claim 13, wherein said receiving comprises an email.

18. The method of claim 13, further comprising viewing a web page after opening said specialized URL, said web page comprising said membership application.

19. The method of claim 13, wherein said current member receives said bonus only if said approved application is within a preset limit of member referrals.
